(19) United States
(12) Patent Application Publication
(10) Pub. No.: US 2025/0069828 A1
(43) Pub. Date: Feb. 27, 2025

(54) DEVICE FOR THE EMERGENCY STOP OF AN INDUSTRIAL MACHINE OR PLANT

(71) Applicant: Pizzato Elettrica S.r.l., Marostica (IT)

(72) Inventor: Simone Zonta, Bassano del Grappa (IT)

(21) Appl. No.: 18/796,314

(22) Filed: Aug. 7, 2024

(30) Foreign Application Priority Data
Aug. 18, 2023 (IT) 102023000017382

(51) Int. Cl. H01H 19/14; G05B 9/02; H01H 19/02; H01H 19/04

(52) U.S. Cl. CPC H01H 19/14; G05B 9/02; H01H 19/025; H01H 19/04

(57) ABSTRACT

An emergency stop device for a machine or industrial plant comprises an emergency button, a rigid protective element close to the emergency button and light signalling means designed to generate a light signal associated with said protective element, wherein the protective element comprises at least one signalling portion which is transparent or translucent with respect to the light signal.

### TECHNICAL FIELD

The present invention refers to an emergency device adapted to find application in the industrial automation sector, in particular for the emergency stop of hazard operation of a machine or an industrial plant.

### STATE OF THE ART

In the industrial automation sector, it is known to provide an emergency button close to a machine or plant to allow an operator to stop the hazardous operation of the machine or plant in an emergency situation.

In some cases, for example in large industrial plants such as process lines for producing steel, aluminum, food, rubber, and more, or in large vehicles or machinery, or more, it is known to provide more than one emergency button along the extension of the industrial plant or machine to allow an operator to stop the plant or machine quickly from any position.

In this context, known emergency buttons have some drawbacks and inconveniences. A first drawback is that it can be difficult for the operator to quickly locate the nearest emergency button in case of emergency, especially if the plant or machine is very large and complex and/or if the environment in which it operates is characterized by poor visibility, obstacles or other.

Emergency devices are also known, for example of the type described in DE4341501, which comprise a mushroom-shaped emergency button having a green portion and a red portion that is movable with respect to the green portion. When the emergency button is not pressed, the green portion and the red portion are both visible, while when the emergency button is pressed, the red portion covers the green portion, making the pressed state of the button visible. DE4341501 also describes a protective guard to protect the emergency button, which comprises a transparent portion from which it is possible to see the green and/or red coloured portions of the emergency button to distinguish whether it is pressed or not.

DE4341501 also describes that the emergency button can be illuminated in green or red by two lamps, to distinguish whether it is pressed or not.

A second drawback, partly opposite to the first, consists in the fact that, in order to restart the machine or plant after having pressed an emergency button, it may be difficult to identify which emergency button was previously pressed, so to reset it. This drawback is also typical in the case of machines or plants with a large number of emergency buttons and/or when the plant or machine is very large and complex and/or if the work environment is characterized by poor visibility, obstacles or other.

There is therefore a need to create an emergency button that can overcome the drawbacks of the known art.

### SCOPE OF THE INVENTION

In particular, an object of the present invention is to provide an emergency device that can be easily located by an operator in the event of an emergency.

Another object of the present invention is to provide an emergency device that can be easily located after it has been pressed in an emergency situation.

A further object of the present invention is to provide an emergency device that can prevent accidental or unintentional activation.

Another object of the present invention is to provide an emergency device that is economical and simple to produce industrially.

### BRIEF DISCLOSURE OF THE DRAWINGS

FIGS. 1, 6 and 7 are schematic axonometric views of a safety device in accordance with respective embodiments of the present invention;

FIGS. 2 and 3 are schematic sections of the safety device of FIG. 1;

FIGS. 4 and 5 are schematic sections of the safety device of FIG. 6;

FIG. 8 is a simplified electrical diagram of the safety device of the present invention.

### SUMMARY OF THE INVENTION

The present invention relates to a device for the emergency stop of a machine or an industrial plant comprising:
an emergency button designed to undergo to a rest state wherein it allows the operation of the machine or industrial plant and an operated state wherein it stops or does not allow the operation of the machine or industrial plant, and having an actuation element defining an actuation axis along which it is suitable to be pressed and designed to operate a switching member adapted to be connected to an external circuit of the machine or industrial plant; and
a rigid protection element close to the actuation element.

According to an aspect of the present invention, the emergency device also comprises light signalling means designed to generate a light signal and associated with the protection element. Furthermore, the protection element comprises at least one signalling portion at least partially transparent or translucent with respect to the light signal.

According to other embodiments, the safety device comprises a power supply and control circuit for the light signalling means designed, or adapted to be designed, to modify the properties of the light signal as a function of the state of the emergency button or of the machine.

The properties of said light signal are selected from a group comprising the flashing frequency, the colour and the light intensity of the light signal.

According to other embodiments, the device further comprises a case containing the switching member and which is provided with a wall which the actuating element is fixed to.

According to other embodiments, the protection element is made as one piece with the wall and the light signalling means are contained inside the case.

According to other embodiments, the wall of the case is also transparent or translucent with respect to the light signal.

According to other embodiments, the light signalling means are contained inside the case and the protection element is fixed to the wall at an opening made in the wall and aligned with the light signalling means.

According to other embodiments, the protection element is fixed to the wall and the light signalling means are integrated into the protection element.

According to other embodiments, the power supply and control circuit comprises at least two different portions, each of which, when powered, is designed to cause the light signalling means to generate a respective light signal with respective properties; and one or more auxiliary switching elements, each of which is associated with the actuation element to be actuated thereby and is designed to be connected to a power source and to one of the two portions to power it or not depending on the state of the emergency button.

According to other embodiments, the power supply and control circuit is of the digital type and comprises a sensor of the state of the emergency button and an electronic control unit connected to the sensor and to said light signalling means designed to control the operation thereof depending on the state of the emergency button.

According to other embodiments, the device also comprises audible signalling means arranged inside the case and connected to said power supply and control circuit. The power supply and control circuit is designed, or adapted to be designed, also to modify the properties of the audible signal depending on the state of the emergency button.

According to other embodiments, the device comprises an electronic control unit connected to the light signalling means and suitable to be connected to an external device to receive an external signal and to modify the properties of the light signal as a function of said external signal.

### BEST MODES OF CARRYING OUT THE INVENTION

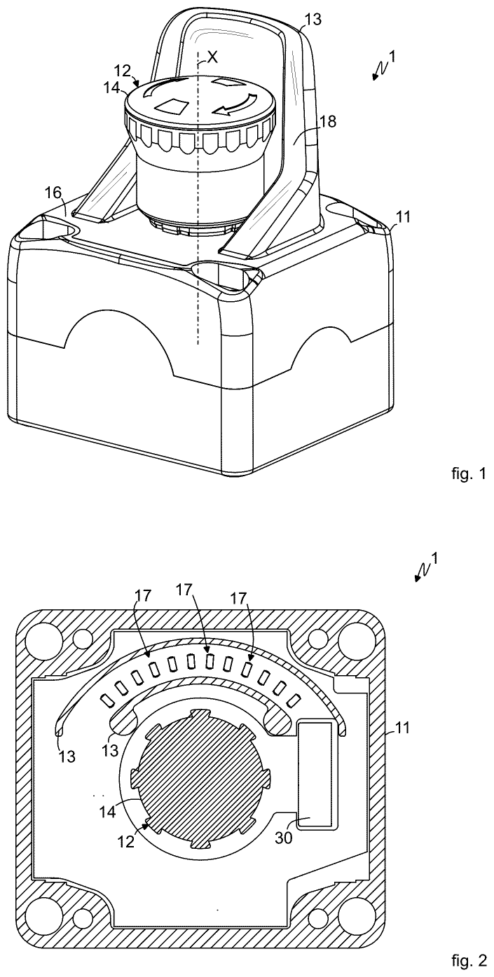

With reference to FIG. 1, a device for the emergency stop of an industrial machine or plant according to the present invention, hereinafter only emergency device 1, comprises a case 11, an emergency button 12 fixed to the case 11 and a protection element 13 associated with the emergency button 12.

The case 11 comprises the protection element 13 and at least one wall 16.

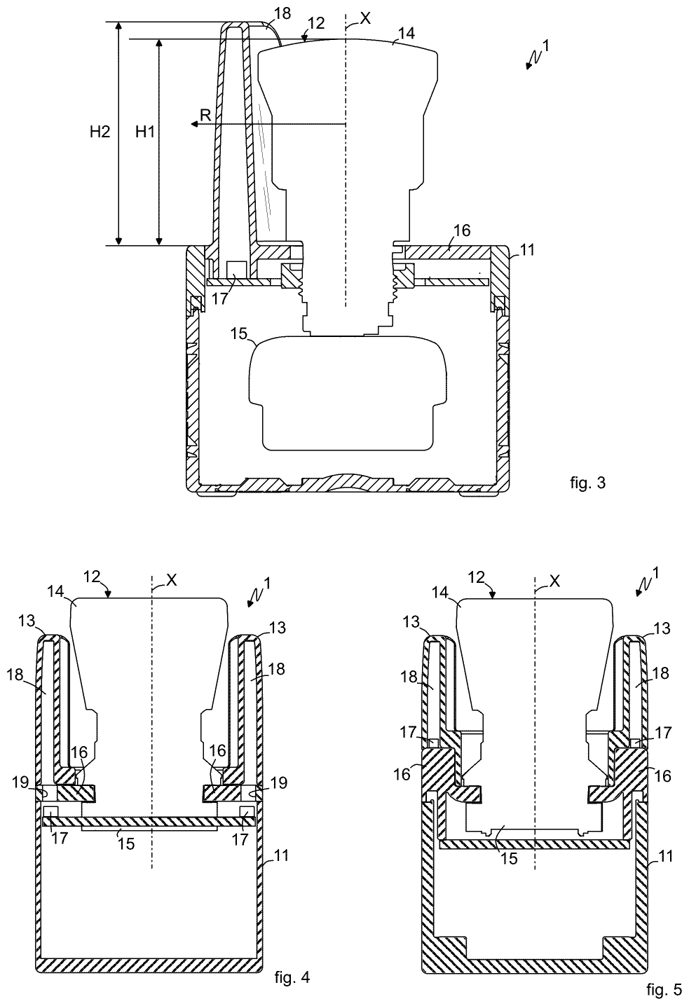

The emergency button 12 comprises an actuation element 14 fixed to a wall 16 of the case 11 which is movable along an actuation axis X to be pressed by an operator. Furthermore, the emergency button 12 also comprises a switching member 15 (FIG. 3) contained in the case 11 and mechanically connected to the actuation element 14. In particular, the switching member 15 is designed to be connected to an external circuit of an industrial machine or plant to switch the latter in response to a pressure on the actuation element 14 by an operator. The external circuit can be connected, for example, to a safety PLC, a safety module or a contactor connected to the power supply of the machine or industrial plant. Furthermore, preferably but not necessarily, the switching element 15 is of the dual-channel type comprising two mechanical contact units. Alternatively, the switching element 15 is of the dual-channel electronic type comprising two OSSDs (Output Signal Switching Devices). In turn, the switching element 15 may be connected to an industrial communication bus to connect the emergency device 1 to a PLC of the machine or other external device.

The emergency button 12 may undergo to a rest state wherein the actuation element 14 is in a rest position and is not pressed and the switching element 15 allows the operation of the machine or industrial plant. Furthermore, the emergency button 12 may undergo to an operated state wherein the actuation element 14 has been pressed into an emergency position and the switching element 15 does not allow or stops the operation of the machine or industrial plant.

The transition from the rest state to the operated state occurs by pressing the actuation element 14 by an operator, while the return to the rest state from the operated state occurs by restoring the rest position of the actuation element 14 by an operator. For example, the rest position of the actuation element 14 is restored by rotating or pulling it by an operator.

However, the actuation element 14 and the switching element 15 may be of any other known type without thereby departing from the scope of protection of the present invention.

The protection element 13 is suitable for protecting the actuation element 14 of the emergency button 12 from accidental actuations or pressures caused by involuntary impacts or hits by an operator or by moving objects.

Preferably, the protection element 13 develops substantially parallel to said actuation axis X, overlapping at least partially the actuation element 14 along at least one radial direction R having its center at a point of said actuation axis X.

In other words, the protection element 13 surrounds the drive element 14 at least partially.

In this case, the protection element 13 comprises a rigid body close to the actuation element 14, for example at least partially surrounding the actuation element 14 around the actuation axis X, and which extends towards the outside of the case 11 at least partially in a direction substantially parallel to the actuation axis X. In this way, the protection element 13 overlaps the actuation element 14 in at least one radial direction R having as its centre a point contained on the actuation axis X.

It should be noted that the protection element 13 may have any shape suitable for protecting the actuation element 14. For example, it may have a circular, partially circular, square plan shape, or defined by any combination of straight and/or curved sections.

When the actuation element 14 is in the rest state it protrudes by a first height H1 from the wall 16 towards the outside of the case 11 and the protection element 13 projects with a second height H2 from the wall 16 towards the outside of the case 11. Preferably, the second height H2 is at least equal to 50% of the first height H1. Even more preferably, the second height H2 is at least equal to 80% of the first height H1. In the embodiments shown in the attached figures, the second height H2 is greater than the first height H1.

According to an aspect of the present invention, the emergency device 1 also comprises light signalling means 17 (FIGS. 2 to 5) associated with the protection element 13 and designed to generate a light signal L (FIG. 8). Moreover, the protection element 13 comprises at least one signalling portion 18 (FIG. 1) which is at least partially transparent or translucent with respect to the light signal L. Preferably, the signalling portion 18 is at least partly transparent or translucent to natural light.

The case 11 contains the light signalling means 17.

The light signalling means 17 are at least partially superimposed on the protection element 13 so that the light signal L may pass through the signalling portion 18 and be visible from the outside.

In this case, the light signalling means 17 comprise a plurality of LEDs arranged underneath the signalling portion 18 of the protection element 13, towards the inside of the case 11.

The surface of the signalling portion 18 is preferably at least 50% of the entire external surface of the protection element 13. Even more preferably, the signalling portion 18 corresponds to the entire protection element 13. In this case the entire protection element 13 is transparent or translucent with respect to the light signal L.

In one embodiment, schematically represented in FIG. 4, the light signalling means 17 are contained in the case 11 and the protection element 13 is fixed to the wall 16. In this embodiment, the wall 16 is opaque with respect to the light signal L and comprises an opening 19 interposed between the light signalling means 17 and the protection element 13.

In another embodiment, schematically represented in FIG. 5, the protection element 13 is fixed to the wall 16 and the light signalling means 17 are contained inside the protection element 13.

In a further preferred embodiment, schematically represented in FIGS. 1 and 3, the light signalling means 17 are contained in the case 11 and the protection element 13 is made as a one piece with the wall 16 without interruption. Preferably, in this embodiment, the protection element 13 and the wall 16 are entirely transparent or translucent with respect to the light signal L.

The light signalling means 17 are connected to a power supply and control circuit 20 designed, or adapted to be designed, to activate or deactivate the light signal L and to modify the properties of the light signal L depending on the state of the emergency button 12. Alternatively, or in addition, the power supply and control circuit 20 is designed, or adapted to be designed, to activate or deactivate the light signal L and to modify the properties of the light signal L depending on the state of the machine or components thereof.

By way of example, the modifiable properties of the light signal L may be selected between the flashing frequency, the color, the light intensity and others.

For example, when the emergency button 12 is in the rest state, i.e. when the actuation element 14 is not pressed, the light signalling means 17 may emit a continuous light signal L and when the emergency button 12 switches to the operated state, i.e. when the actuation element 14 is pressed, the light signalling means 17 generates an intermittent light signal L, or vice versa. Alternatively, when the emergency button 12 is in the rest state, the light signalling means 17 may emit a continuous or intermittent light signal L and when the emergency button 12 switches to the operated state, the light signalling means 17 remains off without generating any light signal L, or vice versa. Alternatively, a first colour, or a first level of light intensity of the light signal

L may be associated with one state of the emergency button 12 and a second colour or a second level of light intensity of the light signal L may be assigned to the other state of the emergency button 12, which is different from the first colour or the first level of light intensity, respectively.

In this way, on the one hand, it is easier for an operator in an emergency situation to locate the nearest emergency device 1 and, on the other hand, it also facilitates and speeds up the search for the specific operated emergency device 1 when it is necessary to restart the stopped machine or plant. This is very advantageous especially for industrial machines or plants wherein there is more than one emergency device 1.

In another embodiment, the light signal L is activated when the machine is on and the light signal L is turned off when the machine is off, or vice versa, or to indicate any other state or operating cycle of the machine.

Optionally, the emergency device 1 also comprises audible signal means 30 (FIGS. 2 and 8) arranged inside the case 11 and designed, or adapted to be designed, to generate an audible signal S depending on the state of the emergency button 12. By way of example, the audible signal means 30 comprise a buzzer, a loudspeaker or any other sound source.

The audible signal means 30 are also connected to the power supply and control circuit 20 which is designed, or adapted to be designed, also to activate or deactivate the audible signal S and to modify the properties of the audible signal S depending on the state of the emergency button 12 or of the machine.

By way of example, the modifiable properties of the audible signal S may be selected between the frequency, the volume and others.

For example, when the emergency button 12 is in the rest state, the audible signal means 30 remain off without generating any audible signal S and when the emergency button 12 switches to the operated state, the audible signal means 30 generate a continuous or intermittent audible signal S, or vice versa.

Alternatively, or in addition, the power supply and control circuit 20 is designed, or adapted to be designed, to activate or deactivate the audible signal S and to modify the properties of the audible signal S depending on the state of the machine or its components.

In one embodiment, the power supply and control circuit 20 is of the analog type and comprises at least two different portions 21, 22 (FIG. 8), each of which, when powered, is suitable to cause the light signal means 17 to generate a respective light signal L with respective properties. Moreover, the power supply and control circuit 20 comprises one or more auxiliary switching members 23, 24 associated with the actuation element 14 to be operated thereby and suitable to be connected to a power source 25 and to at least one of said two portions 21, 22 to power one or the other depending on the state of said emergency button 12.

For example, the power supply and control circuit 20 comprises a first portion 21 which, when powered, is suitable to cause the light signalling means 17 to generate a continuous light signal L. Moreover, the power supply and control circuit 20 also comprises a second portion 22 which, when powered, is suitable to cause the light signalling means 17 to generate an intermittent light signal L.

The auxiliary switching devices 23, 24 may be of the normally open or normally closed type and may be connected to the continuous light signal portion 21 and/or to the intermittent light signal portion 22 so as to obtain a specific desired behavior of the emergency device 1.

Preferably, each portion 21, 22 is associated with reversible connection means (not shown, such as terminal blocks) of each portion 21, 22 to the auxiliary switching devices 23, 24. This is advantageous because it allows the operator who installs the emergency device 1 of the present invention to set the desired light signalling effect.

By way of example, a normally closed auxiliary switching member 23 may be connected to the continuous light signal portion 21 and a normally open auxiliary switching member 24 may be connected to the intermittent light signal portion 22 so that the light signalling means 17 emit a continuous light signal L when the emergency button 12 is in the rest state and an intermittent light signal when the emergency button 12 is in the operated state. The skilled person in the art will readily understand that the auxiliary switching members 23, 24 may be of any known type or combination and arbitrarily connectable to the continuous light signal portion 21 and/or to the intermittent light signal portion 22 or only to one of the same to obtain the desired light signalling effect.

Optionally, the power supply and control circuit 20 comprises a third portion 26 which, when powered, is suitable to cause the audible signalling means 30 to generate a continuous audible signal S. Moreover, the power supply and control circuit 20 also comprises a fourth portion 27 which, when powered, is suitable to cause the audible signalling means 30 to generate an intermittent audible signal S.

In this case, the auxiliary switching members 23, 24 are also designed to be connected to the continuous audible signal portion 26 and/or to the intermittent audible signal portion 27.

By way of example, a normally open auxiliary switching member 24 may be connected to the intermittent or continuous audible signal portion 26 or 27 so that the audible signalling means 20 emit a continuous or intermittent signal when the emergency button 12 is in the operated state. Furthermore, the person skilled in the art will easily understand that the auxiliary switching devices 23, 24 may be of any known type or combination and may be connected arbitrarily to the continuous audible signal portion 26 and/or to the intermittent audible signal portion 27 or only to one of the same to obtain the desired audible signalling effect.

In another embodiment, not shown in the attached figures, the power and control circuit 20 may be of the digital type and comprise a sensor for detecting whether the actuation element 14 is in the rest state or in the operated state and a programmable electronic control unit connected to the sensor and to the light signalling means 17 to control them according to the state of the actuation element 14. Optionally, in these embodiments, the control unit may also be connected to the audible signalling means 30 to control them according to the state of the actuation element 14.

Optionally, in these embodiments, the control unit may be connected to external devices by means of an industrial communication protocol or BUS (IO-Link, ProfiNET, ProfiSafe, or others) to receive an external signal encoding the desired properties of the light signal L and/or the audible signal S. In this case, the control unit is designed to control the light signalling means 17 and/or the audible signalling means 30 as a function of said external signal encoding the desired properties of the light signal L and/or the audible signal S.

Alternatively, or in addition, the control unit may control the operation of the light signalling means 17 and/or the audible signalling means 30 as a function of said external signal.

For example, said external signal may modify the properties of the light signal L and/or the audible signal S as a function of the operating states of the machine or industrial plant or of something else. Alternatively, the switching member 15 may be connected to an external device, i.e. to the machine, and the latter may transmit an external signal to modify the properties of the light signal L and/or the audible signal S as a function of the state of the emergency button 12.

The emergency device 1 of the present invention may be integrated into any known industrial automation device and, in these cases, the case 11 may also comprise the elements of the industrial automation device in which the emergency device 1 is integrated.

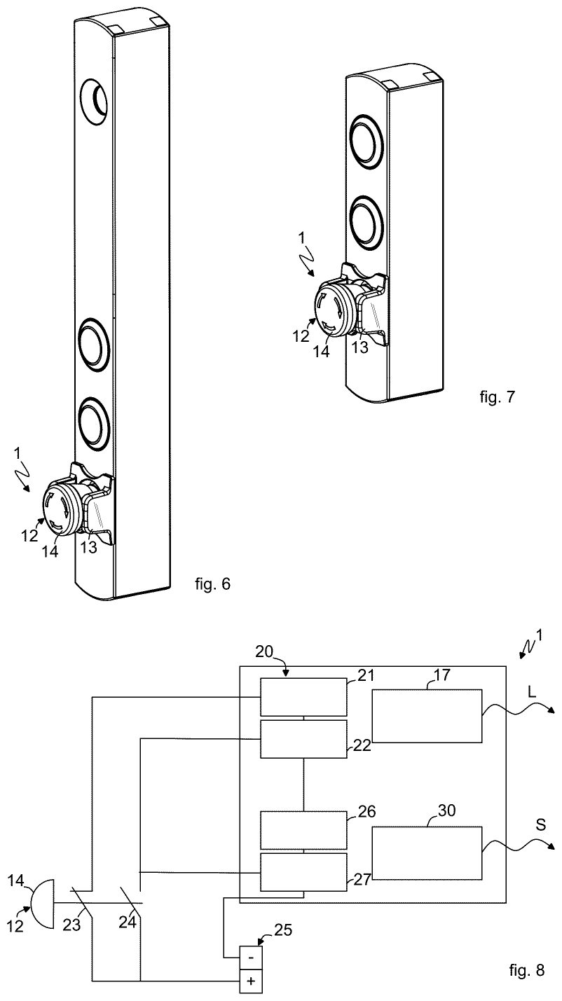

For example, in one embodiment shown as an example in FIG. 6, the emergency device 1 of the present invention is integrated into a safety switch for movable guards. Alternatively, in another embodiment shown as an example in FIG. 7, the emergency device 1 of the present invention is integrated into a button panel with other buttons, for example two other buttons.

1. Device for the emergency stop of a machine or industrial plant comprising:
an emergency button designed to undergo to a rest state wherein it allows the operation of said machine or industrial plant and an operated state wherein it stops or does not allow the operation of said machine or industrial plant, and having an actuation element defining an actuation axis along which it is suitable to be pressed and designed to actuate a switching member suitable to be connected to an external circuit of said machine or industrial plant;
a rigid protection element close to said operation element;
light signalling means designed to generate a light signal and associated with said protection element;
wherein said protection element comprises at least one signalling portion at least partially transparent or translucent with respect to said light signal.

2. The device of claim 1, comprising a case provided with a wall which said actuation element is fixed to.

3. The device of claim 2, wherein said case also comprises said protection element and contains said light signalling means and said switching member.

4. The device of claim 3, wherein said protection element is fixed or made as one piece with said wall and wherein said light signalling means are contained inside said case.

5. The device of claim 1, wherein said protection element develops substantially parallel to said actuation axis, overlapping at least partially with the drive element along at least one radial direction having a point of said actuation axis as the center.

6. The device of claim 1, comprising a power supply and control circuit of said light signalling means designed, or adapted to be designed, to modify the properties of said light signal as a function of the state of said emergency button or of the machine.

7. The device of claim 6, wherein said properties of said light signal are selected from a group comprising the flashing frequency, the colour and the light intensity of said light signal.

8. The device of claim 2, wherein said protection element is made in one piece with said wall and said light signalling means are contained inside said case.

9. The device of claim 2, wherein said wall is also transparent or translucent with respect to said light signal.

10. The device of claim 2, wherein said light signalling means are contained inside said case and said protection element is fixed to said wall at an opening made on said wall and aligned with said light signalling means.

11. The device of claim 2, wherein said protection element is fixed to said wall and said light signalling means are integrated into said protection element.

12. The device of claim 5, wherein said power supply and control circuit comprises at least two different portions, each of which, when powered, is suitable to cause said light signalling means to generate a respective light signal with respective properties; and
one or more auxiliary switching members each of which is associated with the actuation element to be actuated thereby and is designed to be connected to a power source and to one of said two different portions to power it or not depending on the state of said emergency button.

13. The device of claim 5, wherein said power supply and control circuit is of the digital type and comprises a sensor of the state of said emergency button and an electronic control unit connected to said sensor and to said light signalling means designed to control the operation thereof as a function of the state of said emergency button.

14. The device of claim 1, also comprising audible signalling means arranged inside said case and connected to said power supply and control circuit to generate an audible signal, wherein said power supply and control circuit is designed, or adapted to be designed, also to modify the properties of said audible signal as a function of the state of said emergency button.

15. The device of claim 1, comprising an electronic control unit connected to said light signalling means and suitable to be connected to an external device to receive an external signal and to modify the properties of said light signal as a function of said external signal.
